(19) United States
(12) Patent Application Publication
(10) Pub. No.: US 2016/0034986 A1
(43) Pub. Date: Feb. 4, 2016

(54) SYSTEM AND METHOD FOR HEALTH CARE MEDICAL CODING

(71) Applicant: Ana Ortiz, Brooklyn, NY (US)

(72) Inventor: Ana Ortiz, Brooklyn, NY (US)

(21) Appl. No.: 14/450,534

(22) Filed: Aug. 4, 2014

(51) Int. Cl. G06Q 30/04; G06F 19/00

(52) U.S. Cl. CPC G06Q 30/04; G06F 19/322

(57) ABSTRACT

A system and method for electronic medical coding comprising the steps of: compiling electronic medical records for a service provider, where the medical records are related to treatment and procedures performed for a plurality of patients; storing the electronic medical records on a database on a network; scanning the database for key words associated with treatments for a target patient; generating billing codes associated with key words; and tabulating billing codes for a target patient. The method according to the present invention may further include a step of generating a billing statement for the target patient and transmitting a billing statement to a third party payer. The third party payer may be an insurance provider, Medicare or Medicaid.

### BACKGROUND OF THE INVENTION

1. Field of Invention

The present invention relates to a software method and system for generating billing and medical coding.

2. Description of Related Art

Medical professionals and care providers generate a tremendous amount of medical records associated with the treatment and care of their patients. These medical records are generated and stored both in both paper and electronic form. The medical records usually include patient care, conditions, treatments and procedures administered. Each medical record normally associated with an individual patient includes particular medical terminology and procedural terminology associated with the treatments and diagnosis. The medical records are critical for continued treatment and care of patients. Further the records are critical for billing and reimbursement to the health care providers.

Health care providers must normally provide particular medical coding associated with the procedures and treatment performed on patients. Medical coding is a critical step for the medical billing process. Services rendered to a patient are associated with particular medical coding that is submitted for billing and reimbursement purposes to a third party payer such as an insurance company or Medicare. Usually an individual is assigned the task of medical coding and billing, where the coder abstracts and assigns appropriate coding on claims associated with the treatment and care of patients. The coder usually reviews the medical records provided by the medical provider, that is either in paper form or electronic records, and then assigns codes to the report the procedures that were performed to generate a billing statement for a third party payer. The coding process is a complex procedure and many coders are individually trained and educated to perform coding. This coding process helps to avoid having to refile claims or the misfiling of claims to third party payers.

Presently technology lacks any software to specifically scan electronic medical records stored on a database for the electronic or automated assignment of codes associated with the treatment and procedures. Such a system would be optimal for any medical provider to help to efficiently and expediently assign codes for billing purposes.

### SUMMARY OF THE INVENTION

The present invention relates to a method for electronic medical coding comprising the steps of: compiling electronic medical records for a service provider, where the medical records are related to treatment and procedures performed for a plurality of patients; storing the electronic medical records on a database on a network; scanning the database for key words associated with treatments for a target patient; generating billing codes associated with key words; and tabulating billing codes for a target patient. The method according to the present invention may further include a step of generating a billing statement for the target patient and transmitting a billing statement to a third party payer. The third party payer may be an insurance provider, Medicare or Medicaid.

### BRIEF DESCRIPTION OF DRAWINGS

FIG. 1 depicts an overview of a system in accordance with the present invention.

### DETAILED DESCRIPTION

The present invention relates to a system and method of electronic medical coding. The present system involves the electronic collection and storing of medical records for at least one medical care provider. The electronic medical records are stored on a database within a network system. The database in a network system may be then accessed through a medical coding software residing on at least one computer. The medical coding software scans the database but key words associated with the treatment for a target patient. As the database is scanned the software generates billing codes associated with the key words found during the scan. Billing codes have been tabulated for the patient and a billing statement is created for a third party payer. The system coding of the present invention generates the billing statement, which is then sent to a third party payer electronically. A third party payer may be an insurance provider, Medicare or Medicaid.

This particular system and method creates a means for assigning medical coding associated with the treatment of target patients for a medical care provider. The system is contemplated for use with at least one medical care provider at a target medical care facility. The system may be used with a plurality of medical care providers therefore capable of creating a plurality of billing statements for a plurality of medical care providers. In addition, the system further is capable of generating a batch of patient billing over a period of time. A batch of medical billing may involve scanning the database for a single medical provider and generating billing statements for a plurality of target patients that receive treatment from the medical care provider.

The system according to the present invention includes a means for generating a complete billing statement where the billing statement would include at least one patient. The billing statements may be generated on a periodic basis and billing statements may be initiated by user as desired. A user generates these billing statements for the use of a computer connected to a network that accesses the database, which stores electronic medical records. Also from the network is a medical provider input system in the form of a computer tablet or portable station. These medical providers such as the physicians, dentists, occupational therapists, nurses or other medical professionals input medical treatment through software provided within the user stations. The user stations then transmit this data to a stored database. Medical coders utilize stations to generate the billing statements by scanning the medical database in accordance with the system described above.

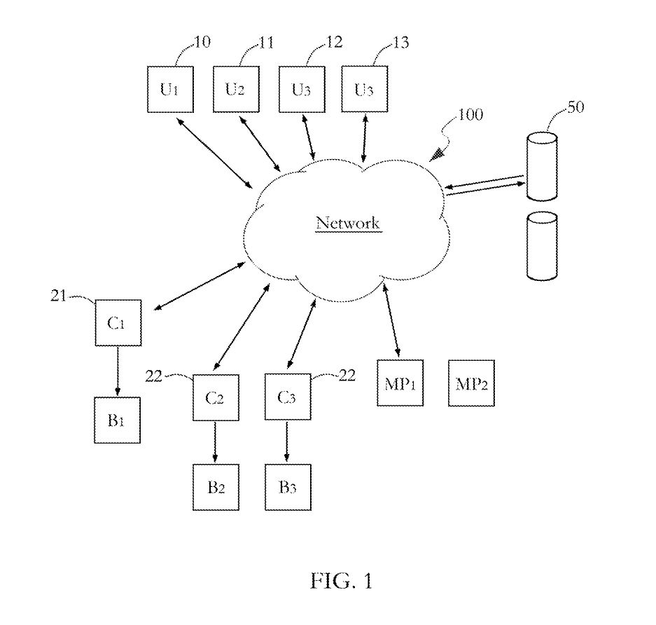

In reference to FIG. 1, a graphical depiction of the system in accordance with the present invention is provided. A network 100 is provided where users U₁ through Uₙ are connected to the network 100. Users 10 through 13 input medical data, which is stored on a database 50 connected to a network 100. This database 50 is accessible by coders C₁ through C₃. Coders utilize software that scans database 50 to search the records that were created by users and stored on database 50. The coders then may generate billing statements shown as B₁, B₂, B₃ to store these billings and then transmit the billing statements to medical payers that also are accessible through network 100.

What is claimed is:

1. A method for electronic medical coding comprising the steps of:
a. compiling electronic medical records for a service provider, where the medical records are related to treatment and procedures performed for a plurality of patients;
b. storing the electronic medical records on a database on a network;
c. scanning the database for key words associated with treatments for a target patient;
d. generating billing codes associated with key words; and
e. tabulating billing codes for a target patient.

2. The method for electronic medical code according to claim 1 further comprising a step of generating a billing statement for the target patient.

3. The method for electronic medical coding according to claim 2 further comprising a step of transmitting a billing statement to a third party payer.

4. The method for electronic medical coding wherein the third party payer is at least one of an insurance provider, Medicare and Medicaid.

5. The method for electronic medical coding according to claim 1 further comprising:
a. scanning the database for a second target patient;
b. generating billing codes for treatment for the second target patient; and
c. tabulating billing codes for the second target patient.

6. The method for electronic medical coding according to claim 1 further comprising
a. scanning the database for a plurality of patients;
b. tabulating billing codes for each of the plurality of patients; and
c. generating a billing statement for each of the plurality of patients.

7. The method for electronic medical coding according to claim 6 further comprising transmitting a batch of billing statements to a third party payer.
